(19) United States
(12) Patent Application Publication
(10) Pub. No.: US 2015/0116986 A1
(43) Pub. Date: Apr. 30, 2015

(54) HEAT CONDUCTIVE DEVICE, BACKLIGHT MODULE, AND LIQUID CRYSTAL DEVICE

(71) Applicant: Shenzhen China Star Optoelectronics Technology Co. Ltd., Shenzhen, Guangdong (CN)

(72) Inventors: Gang Yu, Shenzhen City (CN); Shihhsiang Chen, Shenzhen City (CN)

(21) Appl. No.: 14/119,191

(22) PCT Filed: Nov. 8, 2013
(86) PCT No.: PCT/CN13/86733

§ 371 Date: Nov. 21, 2013

(30) Foreign Application Priority Data
Oct. 31, 2013 (CN) 201310527632.9

(51) Int. Cl. F21V 29/00; G02F 1/1335; F21V 23/00

(52) U.S. Cl. CPC F21V 29/004; F21V 23/005; G02F 1/1336; F21Y 2103/003
USPC 362/97.3; 362/373

(57) ABSTRACT

A heat conductive device is disclosed. The heat conductive device includes at least one collecting frame and at least one conductive plate vertically connected to each other. The collecting frame is for surrounding LEDs and is tightly attached to a mounting surface of the circuit board, and the conductive plate is tightly attached to a back plate. The heat conductive device overcomes the defects that there is no effective heat conductive path between the circuit board and the back plate. The heat accumulated on the circuit board is greatly transmitted to the back plate, and thus the heat conductive efficiency and the heat dissipation efficiency are enhanced.

### BACKGROUND OF THE INVENTION

This application claims priority to China Patent Application No. 201310527632.9 filed on Oct. 31, 2013 entitled, HEAT CONDUCTIVE DEVICE, BACKLIGHT MODULE, AND LIQUID CRYSTAL DEVICE, all of the disclosures of which are incorporated herein by reference in their entirety.

1. Field of the Invention

Embodiments of the present disclosure relate to a heat conductive device, a backlight module and a liquid crystal device.

2. Discussion of the Related Art

With the development of LED material and LED packing, the brightness of the LED products has been enhanced. The LED technology is now adopted in various applications. For example, adopting LEDs to be a backlight source of liquid crystal display is a current trend. This is because the attributes including color, brightness, life cycle, power consumption, and environmental issues of LEDs backlight source make LEDs more attractive over CCFL.

However, the heat dissipation issue resulting from the high brightness and high power consumption of LEDs greatly affect the product performance. It is needed for the LED components to dissipate the heat outward quickly. Currently, the liquid crystal display dissipates the heat outward mainly via alumni back plates. However, especially for edge-type backlight modules, there is no heat dissipation path between the back plate and the backlight module. Thus, the heat can only be dissipated via air, and the heat conductive efficiency and the heat dissipation efficiency are affected.

### SUMMARY

The object of the claimed invention is to provide a heat conductive device, a backlight module and a liquid crystal device for enhancing heat conductive efficiency and heat dissipation efficiency.

In one aspect, a heat conductive device includes: at least one collecting frame and at least one conductive plate vertically connected to each other, the collecting frame is for surrounding LEDs and is tightly attached to a mounting surface of a circuit board, and the conductive plate is tightly attached to a back plate.

Wherein the collecting frame and the conductive plate are metallic sheets.

Wherein each of the collecting frames corresponds to one conductive plate.

Wherein each of the collecting frames corresponds to one LED, and the conductive plate is an integral sheet.

Wherein each of the conductive plates corresponds to one LED, the collecting plate is an integral sheet, and openings are correspondingly arranged on the collecting plate to receive the LEDs.

Wherein the collecting frame and the conductive plate are both integral sheets, and openings are formed corresponding to LEDs so as to receive the LEDs.

In another aspect, a backlight module includes: a circuit board, a plurality of LEDs arranged on a mounting surface of the circuit board and heat conductive devices, the LEDs are spaced apart from each other, the heat conductive device further comprises at least one collecting frame and at least one conductive plate vertically connected to the collecting frame, the collecting frame is for surrounding LEDs and is tightly attached to a mounting surface of the circuit board, and the conductive plate is tightly attached to a back plate.

Wherein the collecting frame and the conductive plate are metallic sheets.

Wherein each of the collecting frames corresponds to one conductive plate.

Wherein each of the collecting frames corresponds to one LED, and the conductive plate is an integral sheet.

Wherein each of the conductive plates corresponds to one LED, the collecting plate is an integral sheet, and openings are correspondingly arranged on the collecting plate to receive the LEDs.

Wherein the collecting frame and the conductive plate are both integral sheets, and openings are formed corresponding to LEDs so as to receive the LEDs.

In another aspect, a liquid crystal device includes: a backlight module comprising a circuit board, a plurality of LEDs arranged on a mounting surface of the circuit board and heat conductive devices, the LEDs are spaced apart from each other, the heat conductive device further comprises at least one collecting frame and at least one conductive plate vertically connected to the collecting frame, the collecting frame is for surrounding LEDs and is tightly attached to a mounting surface of the circuit board, and the conductive plate is tightly attached to a back plate.

Wherein the collecting frame and the conductive plate are metallic sheets.

Wherein each of the collecting frames corresponds to one conductive plate.

Wherein each of the collecting frames corresponds to one LED, and the conductive plate is an integral sheet.

Wherein each of the conductive plates corresponds to one LED, the collecting plate is an integral sheet, and openings are correspondingly arranged on the collecting plate to receive the LEDs.

Wherein the collecting frame and the conductive plate are both integral sheets, and openings are formed corresponding to LEDs so as to receive the LEDs.

In view of the above, the heat conductive devices overcome the defects that there is no effective heat conductive path between the circuit board and the back plate. The heat accumulated on the circuit board are greatly transmitted to the back plate, and thus the heat conductive efficiency and the heat dissipation efficiency are enhanced.

### BRIEF DESCRIPTION OF THE DRAWINGS

FIG. 1 is a schematic view of heat conductive devices assembled with a circuit board in accordance with a first embodiment.

FIG. 2 is a three dimensional view of the heat conductive device in accordance with one embodiment.

FIG. 3 is a schematic view of heat conductive devices assembled with the circuit board in accordance with a second embodiment.

FIG. 4 is a schematic view of heat conductive devices assembled with the circuit board in accordance with a third embodiment.

FIG. 5 is a schematic view of heat conductive devices assembled with the circuit board in accordance with a fourth embodiment.

### DETAILED DESCRIPTION OF THE EMBODIMENTS

Embodiments of the invention will now be described more fully hereinafter with reference to the accompanying drawings, in which embodiments of the invention are shown.

As LED modules is the main component generating the heat of the liquid crystal device, how to quickly dissipating the heat is a common issue in the industry. A plurality of LEDs are spaced apart from each other in the circuit board to form the backlight source, the head generated by the LED is firstly accumulated on the circuit board. Currently, as there is no heat conductive path between the circuit board and the back plate. Therefore, in order to overcome the above problem, the claimed invention established the heat conductive path between the circuit board and the back plate so as to conduct the heat accumulated on the circuit board. Thus, the heat conductive efficiency and the heat dissipation efficiency are enhanced.

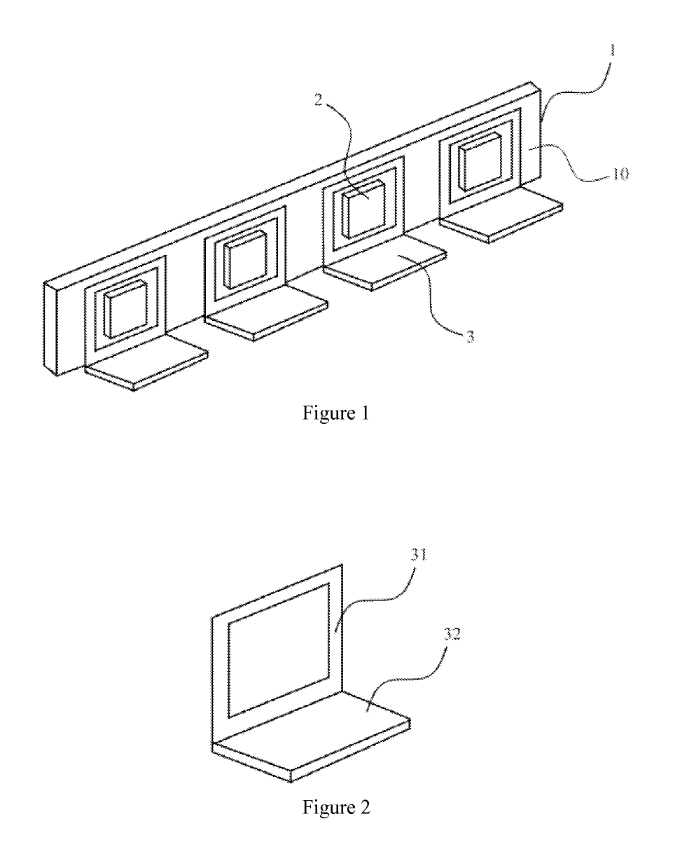

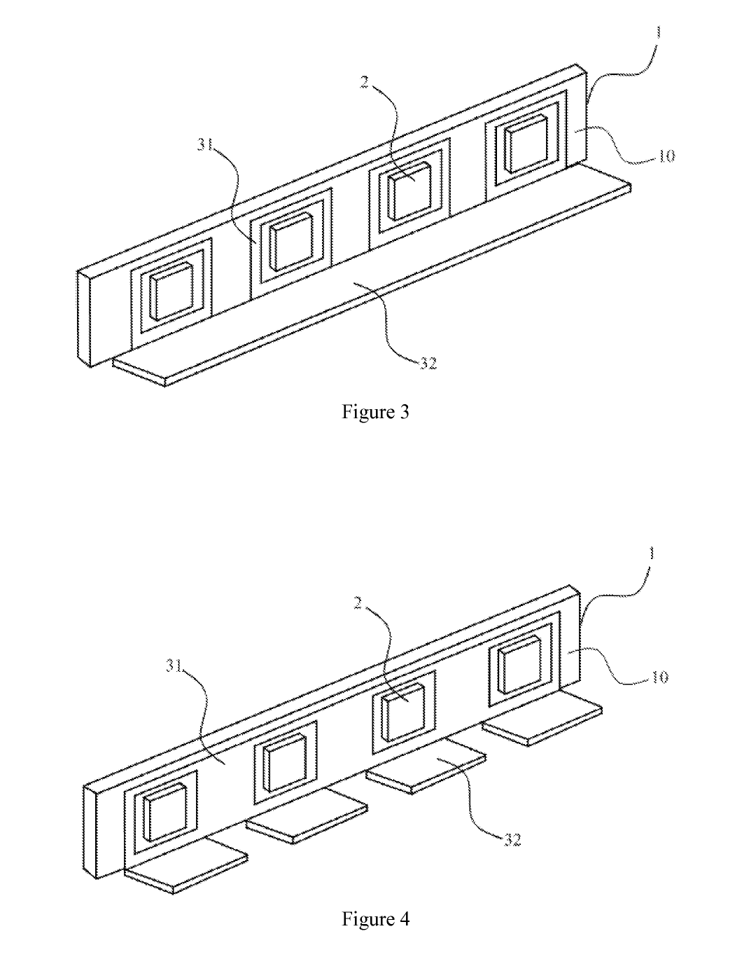

Referring to FIGS. 1 and 2, a plurality of LEDs 2 are arranged on a mounting surface 10 of a circuit board 1 to form a backlight module. The LEDs 2 are spaced apart from each other. In one embodiment, a heat conductive device 3 includes a collecting frame 31 and a conductive plate 32 vertical to each other. The collecting frame 31 is for surrounding the LED 2, and the collecting frame 31 is tightly attached to the mounting surface 10 of the circuit board 1. The conductive plate 32 is for tightly attaching to a back plate. The collecting frame 31 and the conductive plate 32 are sheet-shaped, and are made by metallic materials. The thickness of the collecting frame 31 may be configured to a specific value not exceeding the height of the LED 2 to keep the light emitting efficiency of the LED 2 from being affected.

For the edge-type structure, the circuit board 1 is vertical to the back plate.

According to different configurations, the circuit board 1 have not directly contacted with the back plate, i.e., the heat on the circuit board 1 cannot be transmitted directly to the back plate, or the circuit board 1 only contact with the back plate in the thickness direction, i.e., the contacting dimension is small and thus the heat conductive efficiency is bad. The heat conductive device with L-shaped cross-section of the claimed invention operates as a heat conductive path. That is, the heat of the circuit board 1 are transmitted back to the conductive plate 32 via the collecting frame 31 tightly attached to the mounting surface 10. The heat are then transmitted to the back plate as the conductive plate 32 is attached to the back plate. In other words, the collecting frame 31 surrounds the proximity of the LED 2 to collect the heat from the circuit board 1. The collecting frame 31 and the conductive plate 32 are metallic, and thus the heat collected by the collecting frame 31 are then transmitted to the conductive plate 32. The heat are then transmitted to the back plate as the conductive plate 32 closely contacts with the back plate such that the heat are dissipation outward.

In one embodiment, one collecting frame 31 corresponds to one conductive plate 32, and the number of the collecting frames 31 is the same with the number of the conductive plates 32. That is, one collecting frame 31 is configured to surround one LED 2 to transmit the heat to the connected conductive plate 32. The collecting frame 31 and/or the conductive plate 32 are integrally formed, and will be described hereinafter by three embodiments.

As shown in FIG. 3, in the second embodiment, each of the collecting frames 31 corresponds to one LED 2. Each collecting frame 31 surrounds one LED 2. However, comparing to the conductive plates 32 respectively corresponding to the collecting frame 31, the conductive plate 32 in the second embodiment is an integral sheet. In this way, the contact dimension of the conductive plate 32 and the back plate is increased, and thus more and more heat are transmitted to the back plate. As such, the heat conductive efficiency and the heat dissipation efficiency are enhanced.

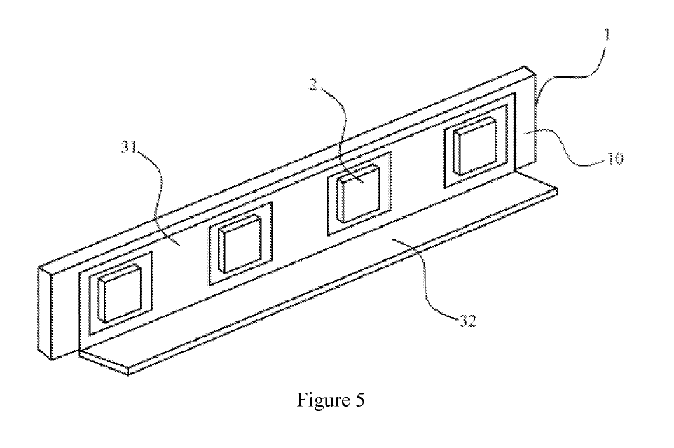

As shown in FIG. 4, in the third embodiment, each of the conductive plate 32 corresponds to one LED 2. The collecting frame 31 is the integral sheet arranged on the mounting surface 10 of the circuit board 1. A plurality of openings are arranged correspondingly to the LEDs 2 to receive the LEDs 2. The integral collecting frame 31 increased the contact dimension of the collecting frame 31 and the circuit board 1. In this way, more and more heat on the circuit board 1 are collected by the collecting frames 31, and thus the heat conductive efficiency and the heat dissipation efficiency are enhanced.

As shown in FIG. 5, in the fourth embodiment combing the advantages of the second and the third embodiments, the collecting frame 31 and the conductive plate 32 are integrally formed. The collecting frame 31 is the integral sheet arranged on the mounting surface 10 of the circuit board 1. A plurality of openings are formed corresponding to the LEDs 2 so as to receive the LEDs 2. Also, the conductive plate 32 is one integral sheet. The integral collecting frame 31 increases the contact dimension of the collecting frame 31 and the circuit board 1 such that more and more heat on the circuit board 1 are collected by the collecting frame 31. The conductive plate 32 also increases the contact dimension of the conductive plate 32 and the back plate. In this way, more and more heat are transmitted to the back plate, and thus the heat conductive efficiency and the heat dissipation efficiency are enhanced.

It is to be noted that the plurality of LEDs 2 are spaced apart from each on the circuit board 1. Referring to FIG. 1, the collecting frames 31 and the conductive plate 32s are arranged corresponding to the LEDs so as to be spaced apart from each other. As the integral-type collecting frame 31 or conductive plate 32 is adopted in the second, third and fourth embodiments, it is not necessary to arrange corresponding collecting frame 31 or the conductive plate 32 for the LEDs 2.

In view of the above, in the fifth embodiment, a backlight module includes the above-mentioned heat conductive devices. In the sixth embodiment, a liquid crystal device includes the above-mentioned backlight module.

The heat conductive devices of the claimed invention overcome the defects that there is no effective heat conductive path between the circuit board and the back plate. The heat accumulated on the circuit board are greatly transmitted to the back plate, and thus the heat conductive efficiency and the heat dissipation efficiency are enhanced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A heat conductive device, comprising:
at least one collecting frame and at least one conductive plate vertically connected to each other, the collecting frame is for surrounding LEDs and is tightly attached to a mounting surface of a circuit board, and the conductive plate is tightly attached to a back plate.

2. The heat conductive device as claimed in claim 1, wherein the collecting frame and the conductive plate are metallic sheets.

3. The heat conductive device as claimed in claim 1, wherein each of the collecting frames corresponds to one conductive plate.

4. The heat conductive device as claimed in claim 1, wherein each of the collecting frames corresponds to one LED, and the conductive plate is an integral sheet.

5. The heat conductive device as claimed in claim 1, wherein each of the conductive plates corresponds to one LED, the collecting plate is an integral sheet, and openings are correspondingly arranged on the collecting plate to receive the LEDs.

6. The heat conductive device as claimed in claim 1, wherein the collecting frame and the conductive plate are both integral sheets, and openings are formed corresponding to LEDs so as to receive the LEDs.

7. A backlight module, comprising:
a circuit board, a plurality of LEDs arranged on a mounting surface of the circuit board and heat conductive devices, the LEDs are spaced apart from each other, the heat conductive device further comprises at least one collecting frame and at least one conductive plate vertically connected to the collecting frame, the collecting frame is for surrounding LEDs and is tightly attached to a mounting surface of the circuit board, and the conductive plate is tightly attached to a back plate.

8. The backlight module as claimed in claim 7, wherein the collecting frame and the conductive plate are metallic sheets.

9. The backlight module as claimed in claim 7, wherein each of the collecting frames corresponds to one conductive plate.

10. The backlight module as claimed in claim 7, wherein each of the collecting frames corresponds to one LED, and the conductive plate is an integral sheet.

11. The backlight module as claimed in claim 7, wherein each of the conductive plates corresponds to one LED, the collecting plate is an integral sheet, and openings are correspondingly arranged on the collecting plate to receive the LEDs.

12. The backlight module as claimed in claim 7, wherein the collecting frame and the conductive plate are both integral sheets, and openings are formed corresponding to LEDs so as to receive the LEDs.

13. A liquid crystal device, comprising:
a backlight module comprising a circuit board, a plurality of LEDs arranged on a mounting surface of the circuit board and heat conductive devices, the LEDs are spaced apart from each other, the heat conductive device further comprises at least one collecting frame and at least one conductive plate vertically connected to the collecting frame, the collecting frame is for surrounding LEDs and is tightly attached to a mounting surface of the circuit board, and the conductive plate is tightly attached to a back plate.

14. The liquid crystal device as claimed in claim 13, wherein the collecting frame and the conductive plate are metallic sheets.

15. The liquid crystal device as claimed in claim 13, wherein each of the collecting frames corresponds to one conductive plate.

16. The liquid crystal device as claimed in claim 13, wherein each of the collecting frames corresponds to one LED, and the conductive plate is an integral sheet.

17. The liquid crystal device as claimed in claim 13, wherein each of the conductive plates corresponds to one LED, the collecting plate is an integral sheet, and openings are correspondingly arranged on the collecting plate to receive the LEDs.

18. The liquid crystal device as claimed in claim 13, wherein the collecting frame and the conductive plate are both integral sheets, and openings are formed corresponding to LEDs so as to receive the LEDs.
